(19) United States
(12) Patent Application Publication
(10) Pub. No.: US 2022/0234473 A1
(43) Pub. Date: Jul. 28, 2022

(54) Powertrains and Thermal Management of The Same

(71) Applicant: XPT (Nanjing) E-powertrain Technology Co., Ltd., Nanjing City (CN)

(72) Inventors: LU SHAO, Weifang City (CN); Lu Bi, Shanghai (CN); Yan Zhao, Shanghai (CN); Lifu Zheng, Shanghai (CN)

(73) Assignee: XPT (Nanjing) E-powertrain Technology Co., Ltd., Nanjing City (CN)

(21) Appl. No.: 17/394,377

(22) Filed: Aug. 4, 2021

(30) Foreign Application Priority Data
Jan. 28, 2021 (CN) 202110119560.9

(51) Int. Cl. B60L 58/27; H01M 10/6571; B60L 50/51; B60L 50/60; H01M 10/667; H01M 10/625; H01M 10/615; H02K 17/12

(52) U.S. Cl. CPC B60L 58/27; H01M 10/6571; B60L 50/51; B60L 50/60; H01M 10/667; H01M 2220/20; H01M 10/615; H02K 17/12; B60L 2220/14; B60L 2240/545; H01M 10/625

(57) ABSTRACT

The present invention provides a method of thermal management for a power train. The temperature power source of the powertrain is continuously monitored. A heating request of is generated if the temperature of the power source falls below a threshold. In response to the heating request, the power controller of the powertrain generates a three-phase current to operate the asynchronous electric motor of the powertrain. The thermal energy therefore generated by the asynchronous electric motor is then provided to the power source for heating up the power source.

### BACKGROUND OF THE INVENTION

### 1. Field of the Invention

The present invention relates to powertrain, and in particular, the thermal management for a powertrain.

### 2. Description of the Prior Art

The advantages of electric vehicles cannot be emphasized enough. However, the adoption of electric vehicles is not without concerns. The performance of battery drops dramatically when operating electric vehicles in low temperature environment and therefore reduce the average driving range. Having a PTC (positive temperature coefficient) heater installed with the battery may solve the issue but it is unsatisfactory and costly.

### SUMMARY OF THE INVENTION

A method of thermal management for a powertrain includes detecting a temperature of a power source of the powertrain, issuing a heating request by a power controller of the powertrain if the temperature falls below a threshold; generating a three-phase current to operate an asynchronous electric motor of the powertrain in response to the heating request; and heating up the power source through thermal energy generated by the asynchronous electric motor.

A powertrain includes a power source, an asynchronous electric motor operable by the power source, and a power controller. The power controller of the powertrain is programmed to operate the asynchronous electric motor by a three-phase current to heat up the power source when a temperature of the power source drops below a threshold.

A non-transitory computer readable medium containing program instructions executed by a processing unit includes: program instructions that control a sensor to detect a temperature of a power source in an electric vehicle; program instructions that control a power controller of the electric vehicle to issue a heating request when the temperature falls below a threshold; program instructions that control the power controller to generate a three-phase current in response to the heating request; and program instructions that operate an asynchronous electric motor of the electric vehicle by the three-phase current. Thermal energy therefore generated by the asynchronous electric motor is provide to heat up the power source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a powertrain according to an embodiment of the present invention.

FIG. 2 is a flowchart of a thermal management method according to an embodiment of the present invention.

FIG. 3 is a schematic diagram of inverse Park transformation according to an embodiment of the present invention.

FIGS. 4 to 6 are schematic diagrams of thermal management for a powertrain according to embodiments of the present invention.

FIG. 7 is a schematic diagram of a system of thermal management according to an embodiment of the present invention.

FIG. 8 is a Table illustrates the values of the three-phase currents at different time slots

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

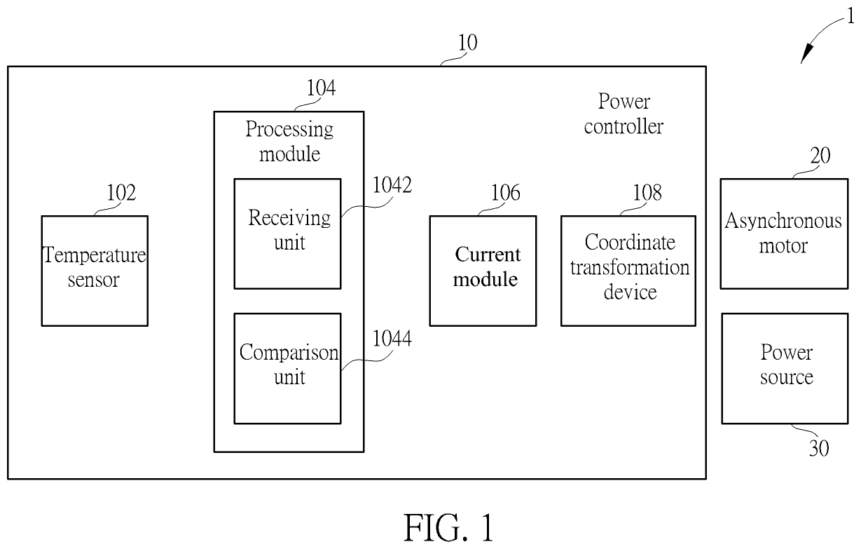

FIG. 1 illustrates a schematic diagram of a powertrain 1 according to the present invention. The powertrain 1 includes a power controller 10, an asynchronous electric motor 20 and a power source 30. The powertrain 1 may be installed in an electric vehicle. The power source 30 may be a high-voltage battery adopted to supply energy, through a converter (or an inverter), to operate the asynchronous motor 20 through the control of the power controller 10. The power controller 10 may be a power electronics unit (PEU).

In one embodiment, the power controller 10 controls the asynchronous electric motor 20 to heat up the power source 30 when the temperature of the power source 30 falls below a threshold. Specially, the power controller 10 generates a three-phase current in response to a heating request to operate the asynchronous electric motor 20. The thermal energy therefore generated by the asynchronous electric motor 20 flows into the power source 30, which is consequently being heated up.

The method of thermal management 2 for a powertrain according to the present invention is illustrated in FIG. 2. The method 2 includes the following steps:

Step S200: Start.

Step S202: Detect the temperature of the power source by the sensor 102.

Step S204: Issue a heating request when the temperature of the power source 30 is lower than a threshold.

Step S206: Generate a three-phase current to operate the synchronous electric motor 20 in response to the heating request.

Step S208: Heat up the power source 30 by the thermal energy generated by the synchronous electric motor 20.

Step S210: End.

In one embodiment, the thermal energy flows into the power source 30 through a conduction which, for instance, may be the same as a conduction pipe or a cooling module in the electric vehicle without having additional hardware.

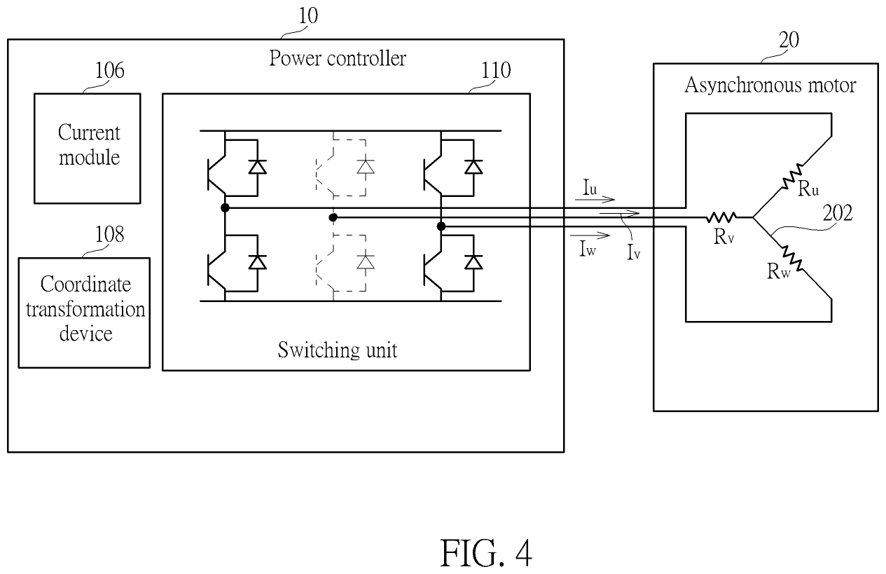

Additionally, as showed in FIGS. 4-6, the powertrain 1 may further include a switching unit 110 programmed to control the current flow of the three-phase current flowing into the asynchronous electric motor 20. It should be noted that the switching unit 110 may be adopted from the existing DC/DC or DC/AC converter, or the inverter of the electric vehicle without having additional circuit.

In one embodiment, the method of thermal management may be smoothly controlled by adjusting the electrical angle of the three-phase current. For example, the electrical angle may start with an initial angle and increase by a set angle at every set time interval. In one example, the electrical angle may start with 30-degree and increase by 60-degree at every set time interval.

Referring back to FIG. 1, the power controller 10 may include a sensor 102, a processing module 104, a current module 106 and a coordinate transformation module 108. The sensor 102 is programmed to detect the temperature of the power source 30. The processing module 104 is programmed to issue the heating request when the temperature of the power source 30 is below the threshold. The current module 106 is programmed to generate a direct sinusoidal current in response to the heating request. The coordinate transformation module 108 is programmed to convert the direct sinusoidal current I_{D} into the three-phase current through an operation of inverse Park Transformation to operate the asynchronous electric motor 20.

In one embodiment, the processing module 104 may include a receiving unit 1042 programmed to receive the temperature sensed by the sensor 102, and a comparison unit 1044 programmed to compare the sensed temperature against the threshold. Referring back to FIG. 1, the power controller 10 may include a sensor 102, a processing module 104, a current module 106 and a coordinate transformation module 108. The sensor 102 is programmed to detect the temperature of the power source 30. The processing module 104 is programmed to issue the heating request when the temperature of the power source 30 is below the threshold. The current module 106 is programmed to generate a direct sinusoidal current in response to the heating request. The coordinate transformation module 108 is programmed to convert the direct sinusoidal current I_{D} into the three-phase current through an operation of inverse Park Transformation to operate the asynchronous electric motor 20.

In one embodiment, the processing module 104 may include a receiving unit 1042 programmed to receive the temperature sensed by the sensor 102, and a comparison unit 1044 programmed to compare the sensed temperature against the threshold.

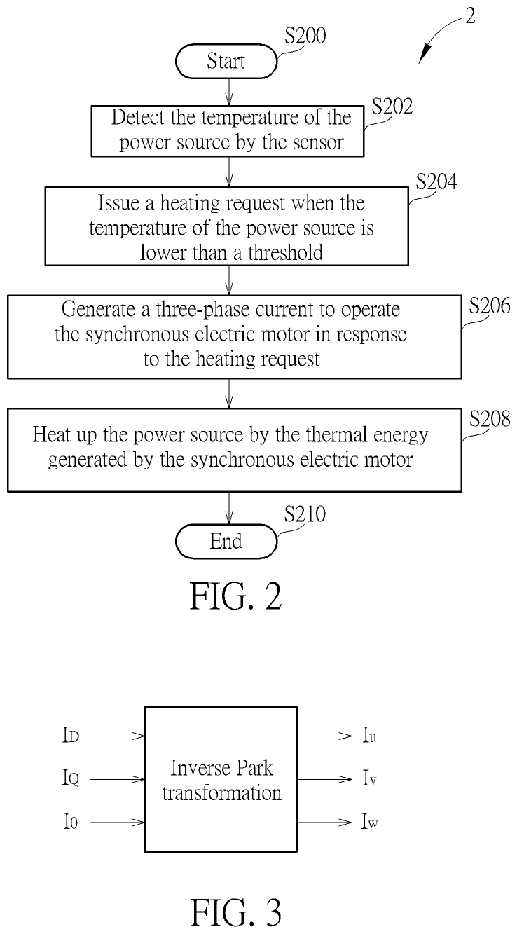

FIG. 3 illustrates a schematic diagram of inverse Park transformation whereby the direct sinusoidal current I_{D} is converted into the three-phase current Iu, Iv and Iw.

As mentioned, the temperature of the power source 30 may be smoothly increased by adjusting the electric angle of the three-phase current applying to the asynchronous electric motor 20. For instance, the electrical angle may start with 30-degree and increase by 60-degree at every set time interval. Specifically, the increment may be made every time when the direct sinusoidal current crosses a zero point.

Referring back to FIG. 1, in response to the heating request generated by the processing module 104, the current module 106 is programmed to generate a direct sinusoidal current I_{D}, quadrature current I_{Q} as well as zero current I₀. In one embodiment, the quadrature current I_{Q} and zero current I₀ are set to zero. The amplitude of the direct sinusoidal current I_{D} and the heating power of asynchronous electric motor 20 are relevant. Thus, the heating power may be controlled by adjusting the amplitude of the direct sinusoidal current I_{D}. The direct sinusoidal current I_{D}, quadrature current I_{Q} and zero current I₀ are shown in the following equation (1):

$${I}_{D} = A * sin ( 2 π f ) \\ {I}_{Q} = 0 \\ {I}_{0} = 0 \qquad ( 1 )$$

Wherein I_{D} is the direct sinusoidal current, A is the amplitude of the direct sinusoidal current, I_{Q} is the quadrature current, I₀ is the zero current.

As also explained above, the coordinate transformation module 108 converts the currents I_{D}, I_{Q} and I₀ generated by the current module 106 into the three-phase currents Iu, Iv, Iw through the operation of inverse Park transformation. The formula of inverse Park transformation is shown in equation (2).

$$\begin{matrix}{I}_{u} \\ {I}_{v} \\ {I}_{w}\end{matrix} = [ \begin{matrix}cos θ & - s in θ & 1 \\ cos ( θ - 12 {0}^{∘} ) & - s in ( θ - 12 {0}^{∘} ) & 1 \\ cos ( θ + 12 {0}^{∘} ) & - s in ( θ + 12 {0}^{∘} ) & 1\end{matrix} ] [ \begin{matrix}{I}_{D} \\ {I}_{Q} \\ {I}_{0}\end{matrix} ] \qquad ( 2 )$$

Wherein Iᵤ, Iᵥ and I_{w} are the three-phase currents, θ is the electrical angle, I_{D} is the direct sinusoidal current, I_{Q} is the quadrature current, I₀ is the zero current. The phase difference of Iᵤ, Iᵥ and I_{w} is 120 degrees respectively.

Following the above embodiment, as mentioned, the quadrature current and zero current are set to zero in the present embodiment, consequently, the Iu, Iv and Iw may be obtained as shown in equation (3).

Iᵤ=cos θ*A*sin(2πf)

Iᵥ=cos(θ−120°)*A*sin(2πf)

I_{w}=COS(θ+120°)*A*sin(2πf) (3)

Wherein Iᵤ, Iᵥ and I_{w} are the three-phase current, θ is the electrical angle.

As previously discussed, the electrical angle θ may be smoothly increased every time when the direct sinusoidal current crosses a zero point. For example, the electrical angle θ may start with 30° (θ=30°) at a first time slot T1. Subsequently, cos θ=√3/2, cos(θ−120°)=0, cos(θ+120°)=√3/2, the three-phase currents Iᵤ, Iᵥ and I_{w} are respectively obtained as shown in equation (4).

$${I}_{u} = \frac{\sqrt{3}}{2} * A * sin ( 2 π f ) \\ {I}_{v} = 0 * A * sin ( 2 π f ) \\ {I}_{w} = - \frac{\sqrt{3}}{2} * A * sin ( 2 π f ) \qquad ( 4 )$$

At a second time slot T2, the electrical angle θ is increased from 30° to 90°, i.e. the electrical angle 90°, cos θ=0, cos(θ−120°)=√3/2, cos(θ+120°)=√3/2, the three-phase currents Iᵤ, Iᵥ and I_{w} are shown in equation (5).

$${I}_{u} = 0 * A * sin ( 2 π f ) \\ {I}_{v} = \frac{\sqrt{3}}{2} * A * sin ( 2 π f ) \\ {I}_{w} = - \frac{\sqrt{3}}{2} * A * sin ( 2 π f ) \qquad ( 5 )$$

At a third time slot T3, the electrical angle θ is increased from 90° to 150°, i.e. the electrical angle θ=150°, cos θ=−⇄3/2, cos(θ−120)°=√3/2, cos(θ+120°)=0, the three-phase currents Iᵤ, Iᵥ and I_{w} are shown in equation (6).

$${I}_{u} = - \frac{\sqrt{3}}{2} * A * sin ( 2 π f ) \\ {I}_{v} = \frac{\sqrt{3}}{2} * A * sin ( 2 π f ) \\ {I}_{w} = 0 * A * sin ( 2 π f ) \qquad ( 6 )$$

At a fourth time slot T4, the electrical angle θ is increased from 150° to 210°, i.e. the electrical angle θ=210°, cos θ=−√3/2, cos(θ−120°)=0, cos(θ+120°)=√3/2, the three-phase current Iᵤ, Iᵥ and I_{w} are shown in equation (7).

$${I}_{u} = - \frac{\sqrt{3}}{2} * A * sin ( 2 π f ) \\ {I}_{v} = 0 * A * sin ( 2 π f ) \\ {I}_{w} = \frac{\sqrt{3}}{2} * A * sin ( 2 π f ) \qquad ( 7 )$$

At a fifth time slot T5, the electrical angle θ is increased from 210° to 270°, i.e. the electrical angle θ=270°, cos θ=0, cos(θ−120°)=−√3/2, cos(θ+120°)=√3/2, the three-phase currents Iᵤ, Iᵥ and I_{w} are shown in equation (8).

$${I}_{u} = 0 * A * sin ( 2 π f ) \\ {I}_{v} = - \frac{\sqrt{3}}{2} * A * sin ( 2 π f ) \\ {I}_{w} = \frac{\sqrt{3}}{2} * A * sin ( 2 π f ) \qquad ( 8 )$$

At a sixth time slot T6, the electrical angle θ is increased from 270° to 330°, i.e. the electrical angle θ=330°, cos θ=√3/2, cos(θ−120°)=√3/2, cos(θ+120°)=0, the three-phase currents Iᵤ, Iᵥ and I_{w} are shown in equation (9).

$${I}_{u} = \frac{\sqrt{3}}{2} * A * sin ( 2 π f ) \\ {I}_{v} = - \frac{\sqrt{3}}{2} * A * sin ( 2 π f ) \\ {I}_{w} = 0 * A * sin ( 2 π f ) \qquad ( 9 )$$

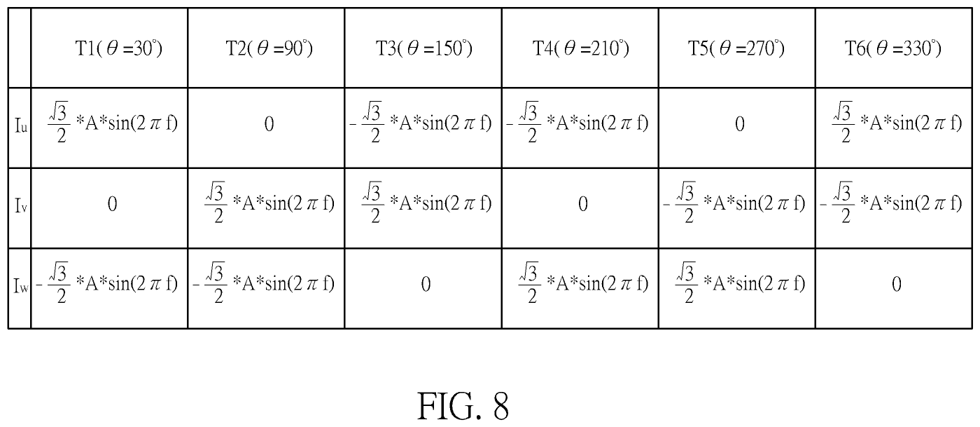

In summary, FIG. 8 illustrates the values of the three-phase currents at different time slots.

FIGS. 4 to 6 are schematic diagrams illustrating the flow control of the three-phase current by the power controllers 10 according to embodiments of the present invention.

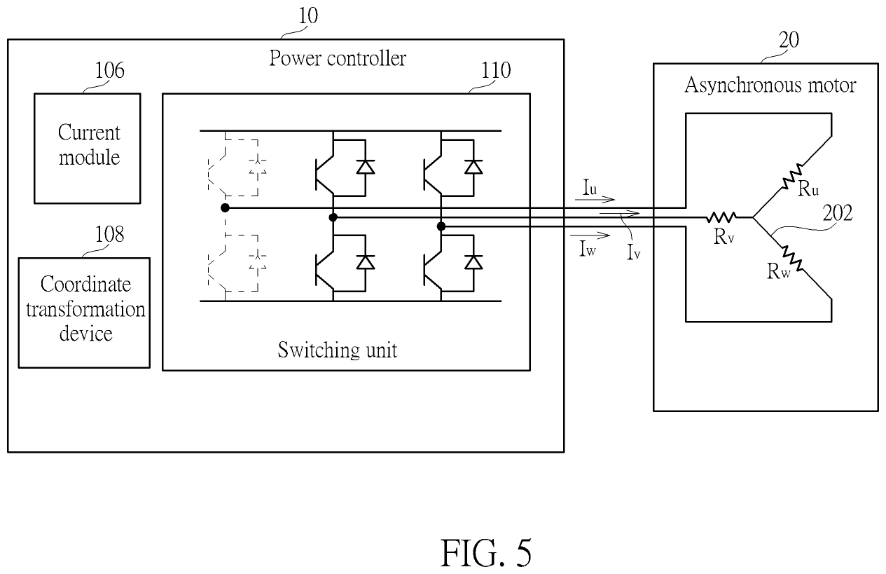

As shown in FIG. 4, the power controller 10 further includes a switching unit 110 programmed to control the current flow of the three-phase current Iu, Iv, Iw flowing into the asynchronous electric motor 20. Equivalently, the stator winding 202 of the asynchronous electric motor 20 may be seems as a first resistor Rᵤ, a second resistor Rᵥ and a third resistor R_{w}. When the three-phase current passes through the stator winding 202, the thermal energy is generated. Essentially, as shown in FIG. 5, the phase current Iᵤ passes through the first resistor Rᵤ, the phase current Iᵥ passes through the second resistor Rᵥ and the phase current I_{w} passes through the third resistor R_{w} to generate the thermal energy. The thermal energy generated by the asynchronous electric motor 20 is provided to the power source 30 to heat up the power source 30.

In an embodiment, please further refer to FIGS. 4 to 6. At the first time slot T1, as shown in FIG. 4 and FIG. 8, the three-phase currents Iu, Iv, Iw obtained at T1 drive the asynchronous electric motor 20. As mentioned, the phase current Iᵥ is zero at T1. Thus, as shown in FIG. 4, through the control of the switching unit 110, only two phase currents Iᵤ and I_{w} pass through the first and the third resistors Rᵤ and R_{w} respectively. That is, at T1, only the first resistor Rᵤ and the third resistor R_{w} are operated to generate the thermal energy.

At the second time slot T2, as shown in FIG. 5 and FIG. 8, the three-phase currents Iu, Iv, Iw obtained at T2 drive the asynchronous electric motor 20. As mentioned, the phase current Iᵤ is zero at T2. Thus, as shown in FIG. 5, through the control of the switching unit 110, only two phase currents Iᵥ and I_{w} pass through the second and the third resistors Rᵥ and R_{W} respectively. That is, at T2, only the second resistor Rᵥ and the third resistor R_{w} are operated to generate the thermal energy.

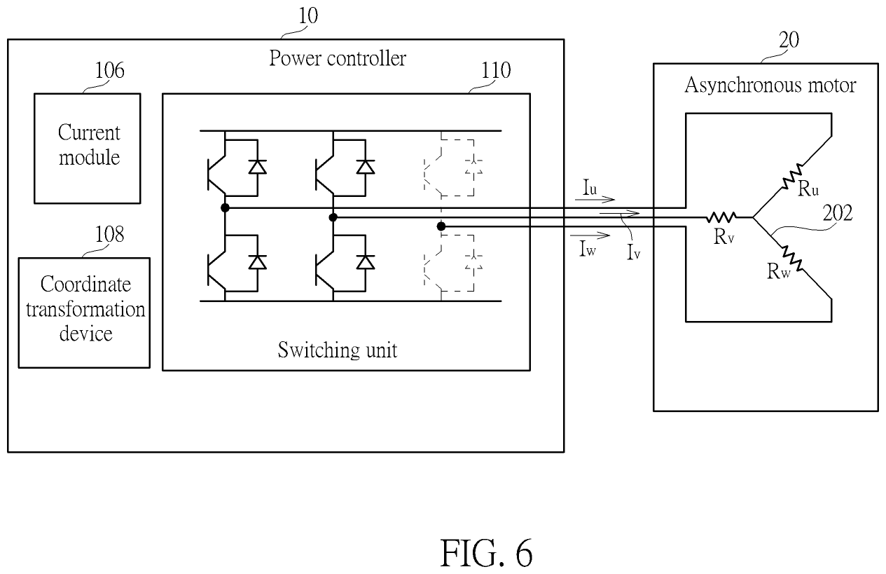

At the third time slot T3, as shown in FIG. 6 and FIG. 8, the three-phase currents Iu, Iv, Iw obtained at T3 drive the asynchronous electric motor 20. As mentioned, the phase currents Iᵤ and Iᵥ pass through the first and the second resistors Rᵤ and Rᵥ respectively. That is, at T3, only the first resistor Rᵤ and the second resistor Rᵥ are operated to generate the thermal energy.

At the fourth time slot T4, as shown in FIG. 8, the three-phase currents Iu, Iv, Iw obtained at T4 drive the asynchronous electric motor 20. Thus, as also shown in FIG. 4, through the control of the switching unit 110, only two phase current Iᵤ and I_{w} pass through the first and the second resistors Rᵤ and R_{w} respectively. That is, at T4, only the first resistor Rᵤ and the third resistor R_{w} are operated to generate the thermal energy.

At the fifth time slot T5, the three-phase currents Iu, Iv, Iw obtained at T5 drive the asynchronous electric motor 20. Thus, as also shown in FIG. 5, through the control of the switching unit 110, only two phase current Iᵥ and I_{w} pass through the second resistor Rᵤ and the third resistor R_{w} respectively. That is, at T5, only the first resistor Rᵤ and the third resistor R_{w} are operated to generate the thermal energy.

At the sixth time slot T6, as shown in FIG. 8, the three-phase currents Iu, Iv, Iw obtained at T6 drive the asynchronous electric motor 20. Thus, as also shown in FIG. 6, through the control of the switching unit 110, only two phase current Iᵤ and Iᵥ pass through the first resistor Rᵤ and the second resistor Rᵥ respectively. That is, at T6, only the first resistor Rᵤ and the second resistor Rᵥ are operated to generate the thermal energy.

Based on the foregoing, by adjusting the electrical angle of the three-phase current, it appears that only two phase currents and two equivalent resistors of the asynchronous electric motor 20 are operable to generate the thermal energy at every given time slot. This will ensure that the temperature of the power source 30 can be smoothly and steadily increased.

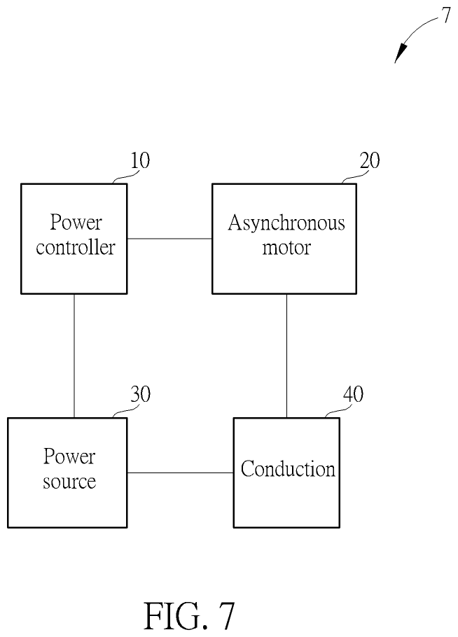

FIG. 7 illustrates a schematic diagram of a system of thermal management 7 according to an embodiment of the present invention. The system 7 includes a power controller 10, an asynchronous electric motor 20, a power source 30, and a conduction 40. The power controller 10 generates a three-phase current to drive the asynchronous electric motor 20 when the temperature of the power source 30 is low. The asynchronous electric motor 20 is operated by the three-phase current and the thermal energy consequently generated is provided to the power source 30 through the conduction 40. As mentioned early, the conduction 40 may be an existing cooling device or an existing cooling circuit of the electric vehicle. Alternatively, the conduction 40 may be any other device capable of conducting the thermal energy, such as thermally conductive fins, cooling fins, and an equipment made of materials with high heat transfer coefficient, but not limited thereto.

Based on the foregoing, the present invention utilizes existing components already in the electric vehicle to heat up the power source of the electric vehicle when the temperature is low. Specifically, the present invention adopts the existing asynchronous electric motor 20 to generate thermal energy, adopts the existing converter (or the inverter) as the switching unit for controlling the current flow of the three-phase current flowing into the asynchronous electric motor 20, and lastly, adopts the existing conduction (such as a conduction pipe) to flow the thermal energy to the power source. As it appears, there is no additional components required to implement the present invention.

In one embodiment, the thermal management may be realized through computer program instructions executable by a processing unit installed in an electric vehicle. The program instructions may be stored in a non-transitory computer readable medium of any kind. The computer readable medium may include program instructions to do the following:
a. control a sensor to detect a temperature of a power source in an electric vehicle;
b. control a power controller of the electric vehicle to issue a heating request when the temperature of the power source is below a threshold;
c. control the power controller of the electric vehicle to generate a three-phase current in response to the heating request; and
d. operate an asynchronous electric motor of the electric vehicle by the three-phase current.

As discussed early, the thermal energy generated by the asynchronous electric motor is provided to heat up the power source.

Additionally, the computer readable medium may also include program instructions to do the following:
e. adjust an electrical angle of the three-phase current at every set time interval;
f. control a switching module of the electric vehicle to adjust the current flow of the three-phase current into the asynchronous electric motor;
g. control a current module to generate a direct sinusoidal current in response to the heating request, and control a coordinate transformation module to transform the direct sinusoidal current into the three-phase current through an operation of inverse Park Transformation.

As also disclosed previously, the electrical angle for the operation of inverse Parker Transformation starts with an initial angle (e.g. 30-degree) and increase steadily by a set angle (e.g. 90-degree) every time when the direct sinusoidal current crosses a zero point.

The various illustrated logical block, molds, routines, and algorithm steps described in connection with the embodiments disclosed herein can be implemented as electronic hardware, or as a combination of electronic hardware and executable software. To clearly illustrate this interchangeability, various illustrative components, blocks, modules and steps have been described above generally in terms of their functionality. Whether such functionality is implanted as specialized hardware, or as specific software instructions executable by one or more hardware devices. Depends upon the particular application and design constrains imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A certification authority can be or include a microprocessor, but in the alternative, the certification authority can be or include a controller, microcontroller, or state machine, combinations of the same, or the like configured to receive, process, and display item data and distributed ledger information for the item. A certification authority can include electrical circuitry configured to process computer-executable instructions. Although described herein primarily with respect to digital technology, a certification authority may also include primarily analog components. For example, some or all of the distributed ledger and certification algorithms described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized software module executed by a certification authority, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the certification authority such that the certification authority can read information from, and write information to, the storage medium. In the alternative, the storage medium can be integral to the certification authority. The certification authority and the storage medium can reside in an application specific integrated circuit (ASIC). The ASIC can reside in an access device or other certification or distributed ledgering device. In the alternative, the certification authority and the storage medium can reside as discrete components in an access device or other certification or ledgering device. In some implementations, the method may be a computer-implemented method performed under the control of a computing device, such as an access device or other certification or distributed ledgering device, executing specific computer-executable instructions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of thermal management for a powertrain, comprising:
detecting a temperature of a power source by a sensor of the powertrain;
issuing a heating request by a power controller of the powertrain if the temperature of the power source falls below a threshold;
generating a three-phase current by the power controller of the powertrain to operate an asynchronous electric motor of the powertrain in response to the heating request; and
heating up the power source through thermal energy generated by the asynchronous electric motor.

2. The method of claim 1, further comprising:
flowing the thermal energy generated by the asynchronous electric motor through a conduction to the power source for heating up the power source.

3. The method of claim 1, further comprising:
heating up the power source by adjusting an electrical angle of the three-phase current at every set time interval.

4. The method of claim 1, further comprising:
generating a direct sinusoidal current by the power controller in response to the heating request;
converting the direct sinusoidal current into the three-phase current through an operation of inverse Parker Transformation to operate the asynchronous electric motor for generating the thermal energy; and
wherein an electrical angle for the operation of inverse Parker Transformation starts with an initial angle and increase steadily by a set angle every time when the direct sinusoidal current crosses a zero point.

5. The method of claim 4, further comprising:
adjusting an amplitude of the direct sinusoidal current to control a heating power of the asynchronous electric motor.

6. A powertrain, comprising:
a power source;
an asynchronous electric motor operable by the power source; and
a power controller, electrically connected to the power source and the asynchronous electric motor;
wherein the power controller is programmed to operate the asynchronous electric motor by a three-phase current to heat up the power source through thermal energy generated by the asynchronous electric motor when a temperature of the power source drops below a threshold.

7. The powertrain of claim 6, further comprising:
a switching module configured to control the current flow of the three-phase current into the asynchronous electric motor.

8. The powertrain of claim 6, wherein the power controller is further programed to adjust an electrical angle of the three-phase current at every set time interval.

9. The powertrain of claim 6, the power controller comprises:
a sensor configured to detect the temperature of the power source;
a processing module configured to issue a heating request when the temperature of the power source detected by the sensor drops below the threshold;
a current module configured to generates a direct sinusoidal current in response to the heating request; and
a coordinate transformation module configured to convert the direct sinusoidal current into the three-phase current;
wherein the three-phase current is applied to the asynchronous electric motor to generate the thermal energy for heating up the power source.

10. The powertrain of claim 9, wherein the direct sinusoidal current is transformed into the three-phase current through an operation of inverse Park Transformation.

11. The powertrain of claim 10, wherein an electrical angle for the operation of inverse Parker Transformation starts with an initial angle and increase by a set angle every time when the direct sinusoidal current crosses a zero point.

12. The powertrain of claim 9, wherein the processing module further comprises:
a receiving unit configured to receive the temperature of the power source from the sensor; and
a comparison unit configured to compare the temperature of the power source with the threshold and issue the heating request accordingly.

13. The powertrain of claim 6, further comprising a conduction to flow the thermal energy into the power source.

14. A non-transitory computer readable medium containing program instructions executed by a processing unit, the non-transitory computer readable medium comprising:
program instructions that control a sensor to detect a temperature of a power source in an electric vehicle;
program instructions that control a power controller of the electric vehicle to issue a heating request when the temperature of the power source is below a threshold;
program instructions that control the power controller of the electric vehicle to generate a three-phase current in response to the heating request; and
program instructions that operate an asynchronous electric motor of the electric vehicle by the three-phase current;
wherein thermal energy generated by the asynchronous electric motor is provided to heat up the power source.

15. The non-transitory computer readable medium of claim 14, further comprising:
program instructions that adjust an electrical angle of the three-phase current at every set time interval.

16. The non-transitory computer readable medium of claim 14, further comprising:
program instructions that control a switching module of the electric vehicle to adjust the current flow of the three-phase current into the asynchronous electric motor.

17. The non-transitory computer readable medium of claim 14, further comprising:
program instructions that control a current module to generate a direct sinusoidal current in response to the heating request; and
program instructions that control a coordinate transformation module to transform the direct sinusoidal current into the three-phase current through an operation of inverse Park Transformation.

18. The non-transitory computer readable medium of claim 17, wherein an electrical angle for the operation of inverse Parker Transformation starts with an initial angle and increase steadily by a set angle every time when the direct sinusoidal current crosses a zero point.

19. The non-transitory computer readable medium of claim 18, wherein the initial angle is 30-degree, and the set angle is 90-degree.
